(19) United States
(12) Patent Application Publication
(10) Pub. No.: US 2018/0150925 A1
(43) Pub. Date: May 31, 2018

(54) COMPUTER-BASED CONTROL OF TIMING WITH WHICH PROPERTY REVIEW ORDERS ARE PROCESSED

(71) Applicant: CoreLogic Solutions, LLC, Irvine, CA (US)

(72) Inventors: Bryan Mark Logan, Rochester, MN (US); Susan Harper Allen, Huntington Beach, CA (US); David Borrillo, Rochester, MN (US); Robert Carpenter, Montara, CA (US)

(21) Appl. No.: 15/365,777

(22) Filed: Nov. 30, 2016

(51) Int. Cl. G06Q 50/16; G06Q 10/06; G06Q 30/02

(52) U.S. Cl. CPC G06Q 50/16; G06Q 30/0278; G06Q 10/06315

(57) ABSTRACT

A system is disclosed that implements various features for enabling property appraisals, and other types of property studies, to be performed more efficiently. One such feature involves the generation of user-specific workflows specifying properties to be visited, and photos to be taken, by specific appraisers or other users. The workflows may be generated using “photos needed” flags in a data repository of incomplete appraisal reports, and may be displayed and used by a mobile workflow application running on mobile devices of such users. Another feature involves automatically incorporating the property photos taken by such users into corresponding appraisal reports as the photos are taken and uploaded via the mobile workflow application. Another feature involves predictively delaying the processing of a current appraisal order based on a prediction that a subsequent appraisal order will be received that can be bundled with the current appraisal order.

### TECHNICAL FIELD

The present disclosure relates to computer systems and processes for improving the speed and efficiency with which property studies, including appraisals and BPO (Broker Price Opinion) studies, are conducted, including the generation of associated reports.

### BACKGROUND

Appraisals of real estate properties are typically conducted by self-employed appraisers, or by business entities that employ a number of appraisers. When a business entity that employs appraisers receives an appraisal order (typically from a lender), the business entity ordinarily decides whether to accept the order, and then assigns the accepted appraisal task to a particular appraiser, such as an appraiser assigned to corresponding geographic area. The appraiser then typically conducts online research to obtain information about the property and comparable properties. The appraiser then typically visits and photographs the property being appraised and the comparable properties. Following those visits, the appraiser typically uses online appraisal report generation software to upload the photos and create an appraisal report. BPOs and other types of property reports may be generated in a similar manner.

### BRIEF DESCRIPTION OF THE DRAWINGS

FIG. 1 is a block diagram of an appraisal workflow system according to one embodiment.

FIGS. 2-6 illustrate example screen displays generated by the mobile workflow application in the system of FIG. 1.

FIG. 7 illustrates a process that may be implemented by the appraisal report generator of FIG. 1 to generate an appraisal report according to one embodiment.

FIG. 8 illustrates a process that may be implemented by the appraisal report generator of FIG. 1 to re-use, or facilitate re-use of, property photos across appraisal reports.

FIG. 9 illustrates a process that may be implemented by the workflow generator of FIG. 1 to generate workflows for appraisers or other users.

FIG. 10 illustrates a predictive process that may be implemented by the appraisal bundling and scheduling component of FIG. 1 to process newly received appraisal orders.

### DETAILED DESCRIPTION OF SPECIFIC EMBODIMENTS

The process by which appraisals are commonly conducted is inefficient in a number of respects. For example, multiple appraisers may visit and photograph the same property in a short period of time, such as when that property is selected as a comparable property for appraisals assigned to different appraisers. As another example, a given appraiser may have to travel to the same remote neighborhood multiple times in a short time period (e.g., on back-to-back days) as the result of the corresponding appraisal orders being received at different times. As another example, appraisers typically spend a significant amount of time uploading the property photographs they take, and incorporating them into the corresponding appraisal reports. These and other inefficiencies adversely contribute to the average cost and completion time of the appraisal process.

The present disclosure describes an appraisal workflow platform that addresses the above and other inefficiencies. Specific, non-limiting embodiments of the platform will now be described with reference to the drawings. Nothing in this description is intended to imply that any particular feature, component or step is essential.

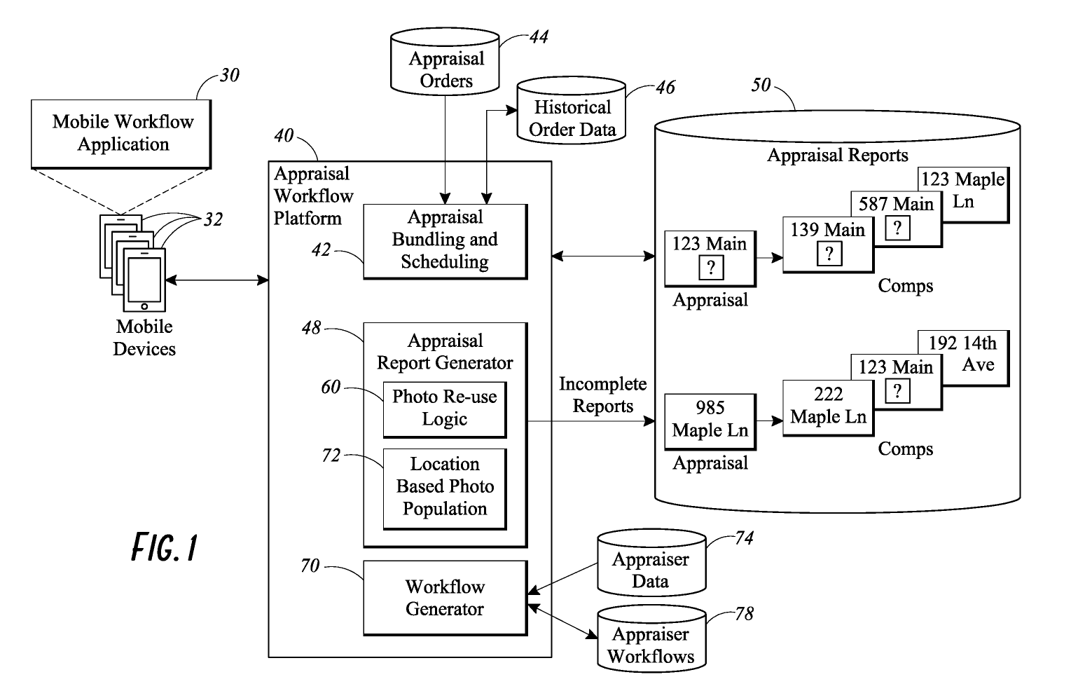

### System Overview (FIG. 1)

FIG. 1 illustrates an appraisal workflow system according to one embodiment. The system includes various components and features for improving the efficiency, and thus reducing the cost and completion time, of the property appraisal process. As will be apparent, some of these components and features may be used without others. The disclosed system and features may also be used to process requests for other types of property reports, including BPOs.

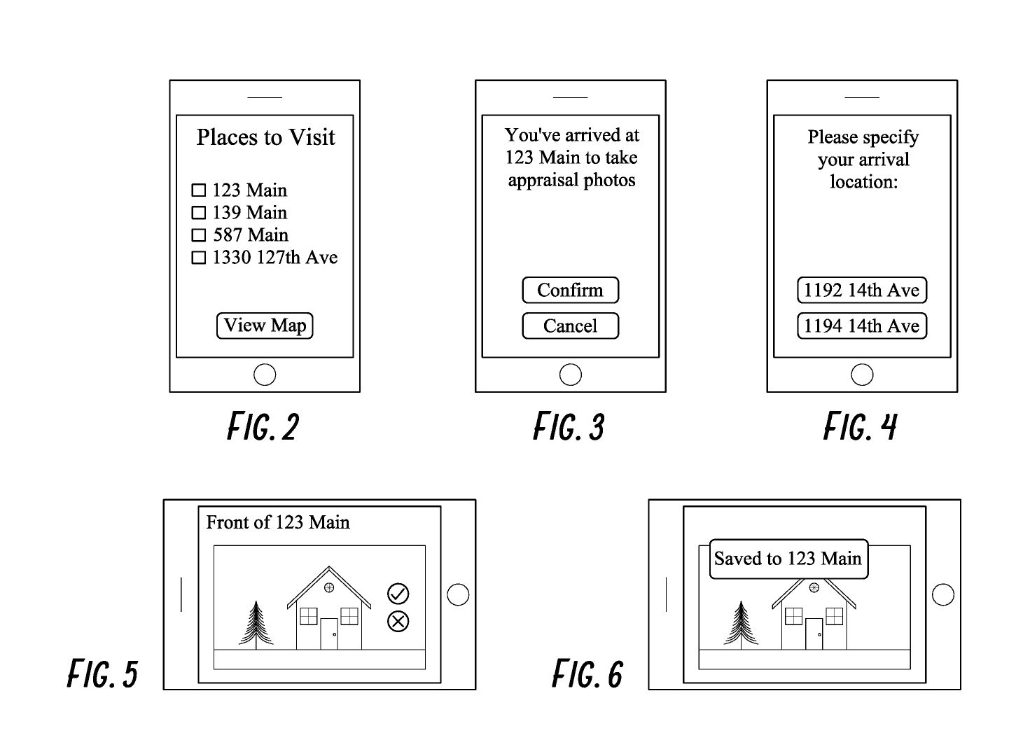

As shown in FIG. 1, the system includes a mobile workflow application 30 (“mobile application”) that runs on the mobile devices 32 (smartphones, tablets, laptops, etc.) of appraisers. As will be described, the mobile application 30 presents each appraiser with a personalized listing of properties to visit for purposes collecting photographs, and possibly other information, for generating appraisal reports. As the appraiser visits these locations and takes the photos, the mobile application 30 may automatically associate the photos with the corresponding properties (based, e.g., on GPS coordinates detected by the mobile device 32), and upload these photos for incorporation into the corresponding appraisal reports (including reports on comparable properties). Example user interface screens of the mobile application 30 are shown in FIGS. 2-6 and discussed below. In some embodiments, the mobile application 30 is omitted, and the users use a mobile browser to access a web site that provides functionality similar to that of the disclosed mobile application.

In some embodiments, the mobile application 30 may also (or alternatively) be used by non-appraiser users tasked with collecting photos for appraisal reports. Thus, although the following description focuses primarily on use cases in which the users are appraisers, the disclosed processes and features are also applicable to users who are not appraisers.

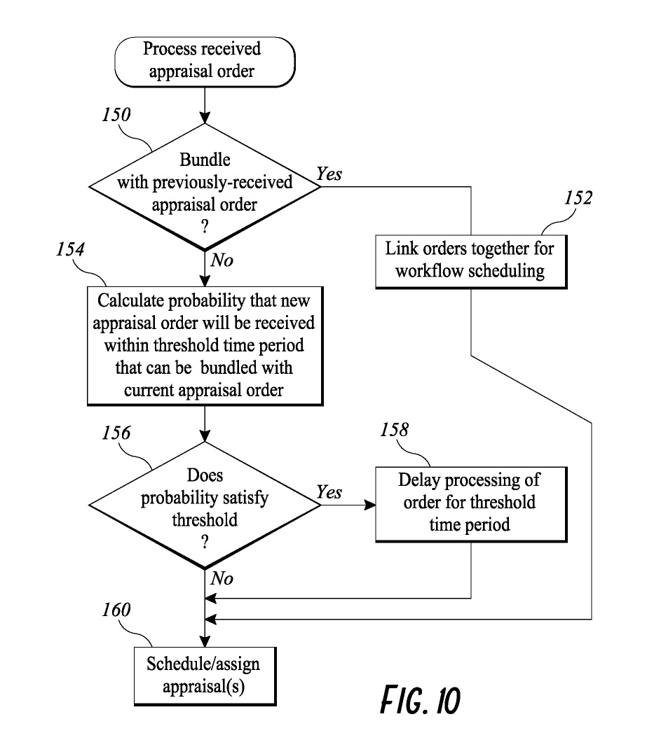

As shown in FIG. 1, the mobile application 30, as installed on the mobile devices 32 of appraisers, communicates over a network with a server-based appraisal workflow platform 40. This platform 40 includes various executable application components that improve the efficiency of the appraisal process. One such component is an appraisal bundling and scheduling component 42 that is responsible for processing appraisal orders received from lending institutions. (As described below, this component 42 can also be used by a lender to bundle appraisal orders for transmission to an appraiser entity.) This component 42 improves efficiency by identifying appraisal orders (and/or BPO orders) that can be bundled together (based on property proximity and possibly other factors) for purposes of generating appraiser workflows. For example, in one embodiment, when a new appraisal order is received, the appraisal bundling and scheduling component 42 uses a database of historical appraisal order data 46 to predict the likelihood that, within a threshold time period (typically in hours), another appraisal order will come in that can be bundled with the newly received order. If the probability is sufficiently high, the appraisal bundling and scheduling component 42 may predictively delay the task of assigning the appraisal to an appraiser or appraiser workflow. If the delay period expires and the new order still is not bundled with another order, the new order is assigned to an appraiser. One embodiment of the appraisal bundling and scheduling component 42 is described below with reference to FIG. 10.

As further illustrated in FIG. 1, the appraisal workflow platform 40 also includes an appraisal report generator 48 that maintains or accesses a database of appraisal reports 50. The appraisal report generator 48 may, for example, be a web-based or other interactive application that is used by appraisers to generate appraisal reports. In some embodiments, the appraisal report generator 48 may automatically (without user involvement) create an initial version of an appraisal report when the appraisal order is processed.

When an appraisal report is initially generated by or with the appraisal report generator 48, the report typically specifies the addresses of the comparable properties (“comps”), but lacks the photos of some or all of these comps. The initial report may also lack the photos of the appraised property. This is illustrated by the question marks in FIG. 1, which represent “photos needed” flags in the database 50. Specifically, in the appraisal report for 123 Main, photos are needed for the appraised property and for the comparable properties at 139 Main and 587 Main. In the appraisal report for 985 Maple Lane, photos are needed only for the comparable property at 123 Main. As described below, the “photos needed” flags are used to automatically generate appraiser-specific workflows. These workflows are preferably presented to the corresponding appraisers via the mobile application 30.

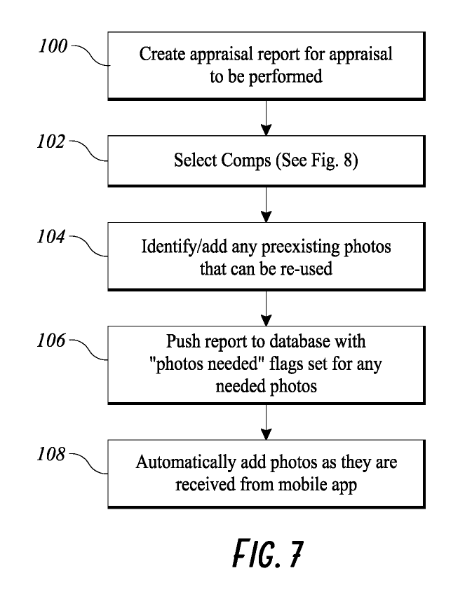

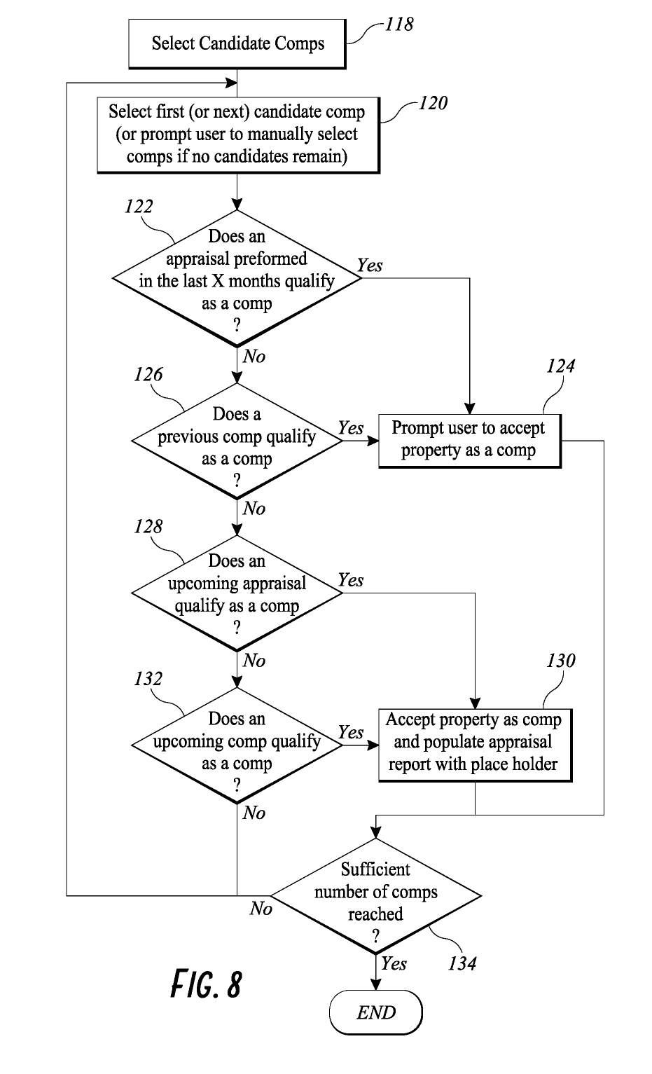

As shown in FIG. 1, the appraisal report generator 48 may include photo re-use logic 60 that detects scenarios in which an already existing photo, or a photo to be taken for another appraisal report, can be reused in a report being generated. This logic 60 may be used, as one example, during the comp selection process. For example, when an appraiser initially creates an appraisal report for a property, the report generator 48 may display a list of suggested comps, together with indications of whether photos already exist in the database 50, or are expected to exist (e.g., are flagged as needed), for each such comp. (Existing regulations, such as the Uniform Standards of Professional Appraisal Practice or USPAP, can be appropriately modified to support this feature.) The appraiser can then take this photo re-use information into consideration in selecting specific properties to use as comps. As another example, the appraiser may specify the comp addresses, and may then be notified of whether any existing or expected photos can be re-used. One embodiment of the photo re-use logic is described below with reference to FIGS. 7 and 8. The photo re-use logic 60 may apply a set of rules to determine whether a preexisting photo can be reused. For example, the photo re-use logic may block a photo from being reused if it is more than X days old or has a resolution (or other quality measure) falling below a particular threshold.

As illustrated in FIG. 1, the system also includes a workflow generator 70 that generates appraiser-specific workflows specifying the properties to be visited by each appraiser or other user. The workflow generator 70 generates these workflows based on the information (including the “photos needed” flags) in the database 50, and based on a repository of appraiser data 74 containing such information as the work schedules and work locations of individual appraisers or other users. Each workflow may, for example, specify a sequence of properties to be visited during a given outing, and may be stored in a database 78. The workflow generator 70 and/or the mobile application 30 may also generate a suggested driving route for visiting these properties. The workflow generator 70 may use one or more optimization criteria to assign tasks to the appraisers; for example, the workflow generator may assign tasks so as to minimize appraiser miles traveled or time spent.

The workflow generator 70 may, in some embodiments, assign a photo generation task/visit to an appraiser who is not assigned to the associated appraisal (where applicable laws permit such assignments). For example, Appraiser A may be assigned to a given appraisal (e.g., by the appraisal bundling and scheduling component 42), who may create an incomplete appraisal report for which photos are needed for a given comp. The workflow generator 70 may then assign the task of taking these comp photos to Appraiser B (e.g., because Appraiser B is closer, or scheduled to be closer, to the comparable property). This ability to distribute the workload associated with a given appraisal report among multiple appraisers enables the appraisal reports to be completed faster, more efficiently, and less expensively.

In some embodiments the workflow generator 70 may generate a workflow for an appraiser “on demand” in response to a request from an appraiser. For example, when the appraiser opens the mobile application 30, the appraiser may be given the option to “create workflow based on current location.” (An option may also be provided for the appraiser to specify a different location, such as by entering an address, a ZIP code, or or city name.) In connection with this option, the appraiser may be given the option to specify one or more constraints, such as an amount of time available or a maximum number of properties to visit. If the appraiser proceeds with this option, the workflow generator 70 may access the database 50 to check for properties for which photos are needed, and may build a custom workflow for the appraiser. Visits that are assigned to an appraiser's workflow may be marked as such in the database 50 so they are not assigned to another appraiser.

The workflow generator 70 may also send push notifications (or other types of alerts, such as text messages) to the mobile device 32 of an appraiser regarding opportunities to photograph nearby properties. For example, when an incomplete appraisal report is generated having a “photos needed” flag set for a particular property (such as a comp), the workflow generator 70 may check to see if any appraisers (or other users of the mobile application 30) are currently within, or are scheduled to be within, a threshold distance of the property, and may send a proactive notification to any such appraisers. (The mobile application 30 may periodically send device location information to the appraisal workflow platform 40 to support this feature.) The notification may give each such appraiser the option to accept to decline the opportunity to photograph the property, in which case the first to accept may “win” the opportunity.

In some embodiments the system 40 may use geofencing to instruct the mobile devices 32 and mobile application 30 regarding tasks. For example, the system 40 may instruct a mobile device 32 to report its entry into one or more specific areas. Upon reporting entry into one of these areas, the system 40 may assign to the mobile device 32 and its user a particular task falling in that area, or may prompt the user to accept the assignment. With this approach, the mobile device 32 need not periodically report its location to the system 40.

As an appraiser visits the properties and takes the associated photos, the mobile application 30 (which may include camera functionality) automatically uploads these photos to the appraisal workflow platform 40. The platform 40 then uses the location information (e.g., property addresses or GPS coordinates) associated with each photo to automatically populate the corresponding appraisal reports in the database 50. This auto-population functionality is represented in FIG. 1 by the block 72 labeled “location-based photo population.”

As one example based on the incomplete appraisal reports shown in FIG. 1, a particular appraiser may be assigned the task of taking photos at 123 Main. The mobile application 30 may use the mobile device's GPS functionality to detect the appraiser's arrival at the property, and then prompt the appraiser to take the appropriate photos. Because photos of this property are needed both for an appraisal of the property itself, and for a comp report for the appraisal of 985 Maple Lane, the mobile application 70 instructs the appraiser to take a full (appraisal) set of photos of the property, rather than the subset of photos needed when the property is merely used as a comp. As the photos are taken, the mobile application 30 may tag each photo with metadata specifying, for example, the type of view (e.g., front, side, rear, etc., as may be specified by the appraiser via the mobile application's UI), the address of the property, the appraiser, and the date, and may upload the photos to the platform 40. The platform 40 may then use the uploaded photos and associated metadata to auto-populate the two appraisal reports for which photos of 123 Main are needed, and may clear the associated “photos needed” flags.

As will be apparent from the foregoing, the disclosed system is capable of improving the speed and efficiency of the appraisal process in multiple ways. First, because the photos are uploaded during the property visits and automatically added to the associated appraisal reports, the reports can be completed faster and with less manual work. Second, because property photos are re-used, where possible, redundant visits to properties are reduced or avoided. Third, because property visits (and associated photo generation tasks) are assigned using optimization criteria, as opposed to simply being assigned to the appraiser to whom the appraisal is assigned, the workload can be distributed much more efficiently, resulting in less average time spent and distance traveled per appraisal.

Additional savings can be achieved in some embodiments where, as described above, incoming appraisal orders can be bundled. For example, by predictively delaying the processing of a new appraisal order, the system may enable that order to be bundled with a subsequently received appraisal order involving a nearby property. The associated property visits may then be assigned by the workflow generator 70 to a common appraiser and outing, reducing the need for multiple trips to the area.

### II. Example Mobile Application Screen Displays (FIGS. 2-6)

FIGS. 2-6 illustrate examples of screen displays that may be presented by the mobile workflow application 30 to an appraiser during an outing. The screen display of FIG. 2 shows a workflow in the form of a sequential list of properties to visit. From this screen, the user can opt to view a map (not show) showing a suggested driving route.

FIG. 3 illustrates a screen display that may be presented when the mobile application 30 detects (via a GPS receiver, WIFI transceiver, or other location-detection technology) arrival at one of the locations in the workflow. From this screen, the user can confirm or cancel the visit to the property. If the user confirms the visit, the mobile application may update the workflow display (FIG. 2) by checking the associated checkbox.

In some scenarios, the mobile application 70 may prompt the user to specify the property being visited, as shown in FIG. 4. Such a display may be presented when, for example, the current GPS coordinates correspond closely to two different properties to be visited, such as two properties that appear in the appraiser's workflow. From this screen, the user can select the property being visited or cancel the visit. The mobile application 70 may also require the user to validate his or her identity via a username and password, a fingerprint, another type of biometric, and/or another authentication process.

Once the user confirms a visit to a particular property, the mobile application 70 may prompt the user to take a sequence of photos of the property. FIG. 5 illustrates one example of a screen display that may be displayed during this process. In this example, the display shows a photo taken by the user of the front of the house, and identifies this photo as being of the “front of 123 Main.” (The photos may, in some embodiments, be taken from within the mobile application 70.) If the user selects the confirmation icon (shown as a check mark in FIG. 5), the photo is uploaded in connection with this address or another unique identifier of the property, together with other metadata such as time/date. The metadata may, but need not, be transmitted as part of the photo file. FIG. 6 shows a screen display with a confirmation message indicating that the photo has been “saved to 123 Main.” As shown in FIG. 5, the user can alternatively discard the photo by selecting the “X” icon. As mentioned above, as the photos are uploaded from the mobile devices 32 of the appraisers, they are automatically added to the associated appraisal reports. In some embodiments, the mobile application 70, or a server-side component of the workflow system, may convert the photos to a standard size and format.

The mobile workflow application 30 may also include one or more modes in which appraisers and other users can complete tasks without the use of pre-generated workflows. For example, in one such mode, the mobile application 30 may, when running, continuously monitor the location of the mobile device 32, and display notifications of nearby properties for which photos are needed. From this display, the user can accept the task of visiting and photographing a given property. In some embodiments, the workflow system may implement a bidding process that enables the appraisers to bid on particular tasks, in which case the system may assign the task to the highest bidder. The process may otherwise be the same as shown in FIGS. 3-6. Geofencing (as described above) may be used to implement this feature.

### III. Process for Generating and Populating Appraisal Report (FIG. 7)

FIG. 7 illustrates a process that may be implemented by the appraisal report generator 48 of FIG. 1 to create appraisal reports. This process may be implemented through interaction with an appraiser, or may be partially or fully automated. In block 100, the process creates an appraisal report for an appraisal to be performed. This task may be performed automatically in response to receipt of an appraisal order, or may be initiated by an assigned appraiser or other user. The appraisal report may be created using preexisting data that is available for the property and surrounding properties.

In block 102, the process selects, or receives a selection of, a plurality of comparable properties (comps) for the property to be appraised. The task of selecting the comps is ultimately performed by the appraiser. The appraisal report generator 48 may inform the appraiser of existing photos to facilitate the re-use of property photos. One embodiment of a process for selecting or suggesting comps is shown in FIG. 8 and discussed below.

In block 104, the process identifies any preexisting photos (of the subject property and/or the comparable properties) that can be re-used. In one embodiment, this task involves searching the appraisal reports database 50, or a supplemental data database of approved photos, for photos tagged with the property address or GPS coordinates of the subject property or a comparable property. Photos taken more than N months ago (e.g., six months) may be disregarded in performing this search so that only recent photos are re-used. In some embodiments the workflow system may also provide an option for the appraiser to purchase or license a property photo from its copyright owner or another authorized source.

In block 106, the process pushes the appraisal report to the database 50 with a “photos needed” flag set for any property for which photos are still needed. As explained above, these flags are used by the workflow generator 70 (FIG. 1) to generate workflows for the appraisers or other users. For example, if comp photos are needed for a given comp, the workflow generator 70 may find an appraiser, BPO agent, realtor, or other user who can visit the property and take the missing photos. As explained below in connection with FIG. 8, in some cases a placeholder flag may be set in the appraisal report for a given property to indicate that photos of the property are expected; these placeholders can be used to prevent the workflow generator 70 from unnecessarily scheduling a redundant visit to the subject property. The “photos needed” flags may also be used by the location-based photo population component 72 to identify appraisal reports to be populated with incoming photos received from the mobile devices 32 of appraisers.

In block 108, as incoming photos are received (from the mobile devices 32 of one or more appraisers) that match the property addresses for which photos are needed, the location-based photo population component 72 (FIG. 1) adds them to the appraisal report (and any other appraisal reports for which such photos are needed) and clears the associated “photos needed” flags. If no “photos needed” flags remain in the report, the appraisal workflow platform 40 may notify the appraiser (e.g., by email or text) that all photos have been obtained and added to the report.

For example, if the newly created appraisal report has the “photos needed” flag set for the property at 123 Main Street, the task of photographing the property may automatically be assigned by the workflow generator 70 to a particular appraiser or other user; once the appraiser visits the property and takes the photos, the appraiser's mobile application 30 will upload them in connection with the property address, and the location-based photo population component 72 will add them to the appraisal report (and any other appraisal reports for which these photos are needed) and clear the associated “photos needed” flag(s).

In addition to photo re-use, the workflow system may enable appraisers to re-use other components of appraisal reports. For example, properties in the same neighborhood should include the same or a similar market conditions addendum. Thus, when an appraisal order is processed, the workflow system may search the database to determine whether a preexisting appraisal report exists from which a market conditions addendum can be taken for re-use. Adjustments (the value of a bedroom, bath, etc.) can be re-used in a similar manner for properties falling in the same neighborhood and price tier.

At any point during the process of FIG. 7, the appraiser may update the report with data, such as data obtained from visiting the property or conducting online research.

The appraisal workflow platform 40 may, in some embodiments, implement a process for compensating appraisers and other users when their photos are re-used by others. For example, the platform 40 may charge an appraisal entity for re-using photos taken by another appraisal entity, and may pay all or a portion of this amount to the source appraisal entity. As another example, the platform may implement a reciprocity system in which those who share photos with others are permitted to proportionally re-use photos taken by others.

### IV. Comp Selection to Increase Photo Re-Use (FIG. 8)

FIG. 8 illustrates a process that may be implemented by the appraisal report generator 48 to further increase the re-use of property photos through the selection of comps for the subject property. This process looks at upcoming (e.g., scheduled or ordered) appraisals, including scheduled visits to comps, to determine whether photos are expected of a property that qualifies as a comp for the subject property and appraisal report. In block 118, the process obtains a list of candidate comps for the subject property (i.e., the property to be appraised). This list may be entered manually by the appraiser, and/or may be generated automatically by the appraisal report generator using a database of property data. This list ideally lists more properties than are needed for the appraisal report.

In block 120, the process selects the first (or next in subsequent iterations) candidate comp on the list, and in block 122, determines whether photos available in the databased from a prior appraisal of the property in the last X months can be re-used as comp photos for the candidate comp. If the answer is yes, the appraiser is notified that existing photos can be re-used, and is prompted to select the property to use as a comp (block 124). The preexisting photos may be displayed to the appraiser at this point to assist the appraiser in deciding whether to select the property and re-use the photos.

If the determination in block 122 is negative, the process in block 126 determines whether photos obtained for a prior comp report on the candidate property in the last X months can be reused as the comp photos for the candidate comp. If the answer is yes, the appraiser is notified that existing photos can be re-used, and is prompted to select the property to use as a comp (block 124).

If the determination in block 126 is negative, the process in block 128 determines whether an appraisal of the currently-selected candidate comp is expected (e.g., scheduled or ordered). This determination may be based, e.g., on the database of appraiser workflows 78 and/or the database of appraisal orders 44. If the answer is yes, the property is selected as a comp (optionally with confirmation by the appraiser), and the appraisal report is populated with a placeholder flag to indicate that photos are expected.

If no upcoming appraisal of the candidate property is scheduled in block 128, the process in block 132 determines whether the candidate property is selected as an upcoming comp for another appraisal report. This determination may be based, e.g., on the database of appraiser workflows 78 and/or on the incomplete appraisal reports stored in the database 50. If the answer is yes, the process in block 130 selects the property as a comp for the current appraisal report (optionally with confirmation by the appraiser), and populates the current appraisal report with a placeholder flag to indicate that photos are expected.

In block 134, the process determines whether a sufficient (e.g., predefined or appraiser-selected) number of comps have been selected for the current appraisal report. If an insufficient number has been reached, the process is repeated using the next candidate comp property. If the process of FIG. 8 does not result in a sufficient number of comps being selected, the appraiser can select as a comp a property for which no suitable photos exist or are expected (not shown).

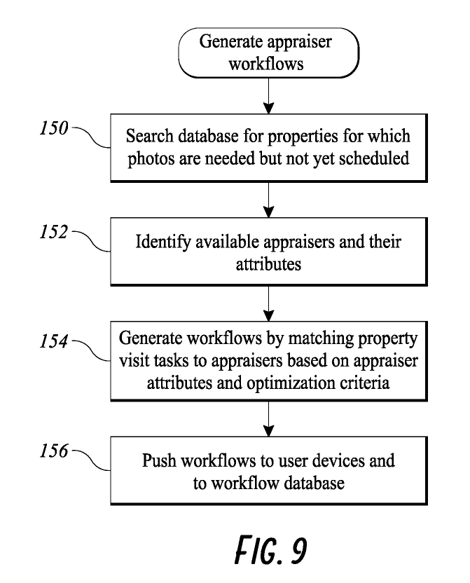

### V. Generation of Optimized Workflows (FIG. 9)

FIG. 9 illustrates a process that may be implemented by the workflow generator 70 to generate optimized workflows for appraisers or other users. In this particular example, the attributes (e.g., locations and schedules) of multiple appraisers are looked at in combination for purposes of assigning property visits (including photo generation tasks) to individual appraisers. In block 150, the process searches the database of appraisal reports 50 to identify properties for which photos are needed and not yet scheduled/expected. In block 152, the process accesses the database of appraiser data 74 to identify appraisers to which the associated property visits can potentially be assigned, and to look up associated appraiser attributes. The appraiser attributes may include, for example, appraiser locations (current and/or scheduled), appraiser work schedules, specialties (e.g., for handling specific types of properties), qualifications, and appraiser preferences (e.g., regarding types of jobs or numbers of jobs to be performed per day). In some embodiments the appraiser data may also include information about non-appraiser users who can, e.g., take external photos but who are not qualified to perform a full appraisal.

In block 154 of FIG. 9, the process matches the identified property visit (photo generation) tasks to individual appraisers based on the appraiser attributes and one or more optimization criteria. The optimization criteria may, for example, seek to minimize appraiser distances traveled, appraiser time spent, average time to obtain photos, or maximum time to obtain photos. In block 156, the resulting workflows are transmitted to the mobile devices 32 of the appraisers for display in the mobile application 30. In some embodiments, the appraisers have the option to decline all or a portion of a workflow.

As explained above, the workflow generator 70 may also assign tasks and generate workflows in other contexts or modes, such as an “on demand” mode that allows an appraiser to request and immediately obtain a workflow or a single-task assignment.

### VI. Predictive Delay of Appraisal Order Processing to Increase Bundling (FIG. 10)

FIG. 10 illustrates a predictive process that may be implemented by the appraisal bundling and scheduling component 42 of FIG. 1 to process newly received appraisal orders 44. This process uses the database of historical appraisal order data 46 to predict the likelihood that another order will be received, within a given time window, that can be bundled with the current order. The database 46 preferably stores a history of the appraisal orders received by the platform 40 (including date and time of receipt) and the property locations associated with such orders. The process of FIG. 10 may be implemented regardless of whether the system implements the processes of FIGS. 7 and 8, and the processes of FIGS. 7 and 8 can be implemented without the process of FIG. 10.

In block 150, the process determines whether the new appraisal order can be bundled with a pending appraisal order, such as an order whose processing has been predictively delayed via block 158, described below. This task involves determining whether any pending appraisal orders exist for properties that are within a threshold distance (e.g., 5 miles) of the property corresponding to the new order, and/or that have preferred availably for inspection. The threshold distance may, in some embodiments, be dependent upon the population density of the associated region. If the new order can be bundled with a pending order, the two orders are linked together (block 152) for purposes of assigning and/or scheduling the appraisals (block 160), such that the property visits to the associated properties are, or at least can be, performed by the same appraiser on the same day. In one embodiment, when two linked orders are assigned to an appraiser, the system notifies the appraiser that the orders are linked. In some embodiments the process may enable three or more appraisal orders to be bundled; for example, a delayed appraisal order may be bundled with two or more later-received appraisal orders that come in during the delay period.

If the new order cannot be bundled with a preexisting order, the process in block 154 uses the database of historical data 46 to calculate the probability of receipt of a new appraisal order, within a threshold period of time (e.g., 12 hours or 1 day), that can be bundled (due to the distance condition being satisfied) with the received order. In one embodiment, the process initially identifies all prior orders (e.g., within the last year or N years) for properties falling within the threshold distance (e.g., 3 miles, 5 miles, etc.) of the subject property. From this data, the probability can be calculated in various ways. For example, the probability can be calculated without regard to the timing with which the historical orders were received over the relevant time period. Alternatively, the process may use an algorithm that accounts for seasonal cycles or trends in the data; for example, if the new order is received during a particular day of the week or month of the year in which appraisal rates are relatively high, the probability calculation may account for this. The probability calculation may also give more weight to recent historical data (e.g., orders received over the last month or N months) than to older historical data, so that population density changes and recent appraisal treads are better reflected.

In block 156, the calculated probability is compared to a probability threshold (e.g., 40%, 50% or 60%) to determine whether to delay processing of the new order. If the threshold is satisfied (e.g., meets or exceeds the threshold), the process in block 158 delays the order for the threshold time period (or another selected time period), such as by holding it in an electronic queue. If another order arrives during this time period that can be bundled with the delayed order, the two orders will be linked together as described above with reference to block 152; otherwise, the order will be processed in block 160 once the threshold time period expires.

The process of FIG. 10 can be modified in various ways. For example, rather than calculating the probability as in block 154, the process could calculate the delay interval at which the probability reaches a certain threshold, such as 40% or 50%. For example, the process could calculate the delay time period that would be needed for the probability (of another order arriving that can be bundled with the current order) to reach a certain threshold, such as 50%; the process could then compare this amount of time to a time threshold to determine whether (and/or how long) to delay the processing of the new order. Another modification involves outputting the probability or time delay calculation to an administrator who decides whether, and/or how long, to delay the processing of the new order.

Referring again to FIG. 1, the appraisal workflow platform 40, including its illustrated components 42, 48, 60, 70, 72, may be implemented by a computer system programmed with executable program modules stored on one or more computer-readable media (hard disk drives, solid state memory devices, etc.). The appraisal workflow platform 40 may be distributed or replicated across multiple physical servers or other computing devices of the computer system, which may or may not be co-located. Each such server typically includes one or more hardware processors that execute program instructions, a solid state memory, a network interface, and various other hardware components. The computer system may, in some embodiments, be a cloud computing system. The functionality of the components of the appraisal workflow platform 40 may be distributed among software components differently than shown in FIG. 1, and some components and functions may be omitted in some embodiments.

The various data repositories 44, 46, 50, 74, 78 shown in FIG. 1 may include databases, flat file systems, and/or other types of data storage systems, and may use hard disk drives, solid state memories, and/or other types of non-transitory computer storage devices. Although shown as separate data repositories, two or more of the illustrated data repositories 44, 46, 50, 74, 78 can be combined.

The mobile devices 32 may include smartphones, tablet computing devices, laptop computers, smart watches, computerized eyewear devices, and other types of portable wireless devices capable of running applications. The mobile application 30 may be implemented in executable program code that is stored in the non-transitory computer storage (e.g., solid state memories) of the mobile devices 32. All of the processes and process steps described above (including those of FIGS. 7-10) may be embodied in, and fully automated via, the program components described above. Some or all of the functions may instead be performed by specialized computer hardware, such as ASICs or FPGA devices.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system for controlling a timing with which appraisal orders are processed, the system comprising:
a database of historical appraisal order data that specifies, for each of a plurality of appraisal orders, at least a geographic location and a time associated with the appraisal order; and
a computing system comprising one or more computing devices, the computing system programmed to process a newly received appraisal order by a process that comprises:
determining a geographic location associated with the newly received appraisal order; and
generating, based on the database of historical appraisal order data, data reflective of a probability that another appraisal order will be received within a threshold time period that corresponds to the geographic location, said data reflective of the probability representing a likelihood that the newly received appraisal order can be bundled with a later-received appraisal order if processing of the newly-received appraisal order is delayed.

2. The system of claim 1, wherein the computing system is further programmed to determine, based at least partly on the data reflective of the probability, whether to delay processing of the newly received appraisal order.

3. The system of claim 1, wherein the process further comprises selecting an amount of time by which to delay processing of the appraisal order.

4. The system of claim 1, wherein the computing system is further programmed to determine whether the newly received appraisal order can be bundled with a pending appraisal order for which processing has been delayed.

5. The system of claim 1, wherein the data reflective of a probability comprises a probability value, and the process further comprises comparing the probability value to a threshold.

6. The system of claim 1, wherein the data reflective of a probability comprises a time period for which the newly received appraisal order must be delayed for a threshold probability to be reached.

7. The system of claim 1, wherein generating the data reflective of the probability comprises giving different amounts of weights to different past appraisal orders.

8. The system of claim 1, wherein generating the data reflective of the probability comprises accounting for cyclical variations in timings of appraisal orders.

9. The system of claim 21, wherein the process further comprises outputting, to a human operator, the data reflective of the probability, and receiving from the human operator at least an indication of whether processing of the newly received appraisal order should be delayed.

10. The system of claim 1, wherein the computing system is additionally configured to generate, for specific appraisers, appraiser-specific workflows specifying sequences of properties to be visited by the respective appraisers.

11. The system of claim 10, further comprising a mobile application that runs on mobile devices of the appraisers, the mobile application configured to display a workflow, and providing functionality for uploading to the computing system photos taken in connection with the workflow.

12. The system of claim 11, wherein the computing system is programmed to automatically add the uploaded photos to corresponding appraisal reports.

13. A computer-implemented process for controlling a timing with which a received property study order is processed, comprising:
determining a property location specified by the order;
selecting a geographic region that encompasses the property location, the geographic region selected to facilitate bundling of appraisal orders for which property visits can be combined into a single outing;
generating, based on a database of historical property study order data, data reflective of a probability that, within a threshold time period, another property study order will be received for a property falling in the geographic region; and
determining, or providing an option for a human operator to determine, based on the data reflective of the probability, whether to delay processing of the property study order.

14. The process of claim 13, wherein the process comprises determining whether to delay processing of the newly received property study order.

15. The process of claim 13, further comprising determining an amount of time by which to delay processing of the property study order.

16. The process of claim 13, further comprising determining whether the received property study order can be bundled with a pending property study order for which processing has been delayed.

17. The process of claim 13, wherein the data reflective of a probability comprises a probability value, and the process further comprises comparing the probability value to a threshold.

18. The process of claim 13, wherein the data reflective of a probability specifies a time period for which the received property study order must be delayed for a threshold probability to be reached.

19. The process of claim 13, wherein generating the data reflective of the probability comprises giving different amounts of weights to different past property study orders.

20. The process of claim 13, wherein generating the data reflective of the probability comprises accounting for cyclical variations in quantities of received property study orders.

21. The process of claim 13, further comprising outputting, to a human operator, the data reflective of the probability, and receiving from the human operator at least an indication of whether to delay processing of the received property study order.
